(19) United States
(12) Patent Application Publication
(10) Pub. No.: US 2019/0340894 A1
(43) Pub. Date: Nov. 7, 2019

(54) MULTI-FUNCTIONAL LIGHT PIPE FOR OCCUPANCY AND AMBIENT LIGHTING CONTROL

(71) Applicant: ABL IP Holding LLC, Atlanta, GA (US)

(72) Inventors: John R. Johnson, Flowery Branch, GA (US); Steven Downs, Lilburn, GA (US); Troy T. Miller, Cumming, GA (US); Brett S. Carlson, Atlanta, GA (US)

(21) Appl. No.: 16/402,518

(22) Filed: May 3, 2019

Related U.S. Application Data
(60) Provisional application No. 62/666,804, filed on May 4, 2018.

(51) Int. Cl. G08B 5/38; H05B 37/02

(52) U.S. Cl. CPC G08B 5/38; H05B 37/0272; H05B 37/0227; H05B 37/0281; H05B 37/0218

(57) ABSTRACT

A light and motion detection sensor includes a light-emitting diode (LED) indicator configured to provide intermittent light from the LED indicating that the light and motion detection sensor is operating, a photocell sensor configured to detect ambient light, a passive infrared (PIR) sensor having a lens and configured to detect infrared radiation, and a sensor retainer configured to retain the light and motion detection sensor in a mounting, transmit ambient light to the photocell sensor, and transmit the intermittent light from the LED indicator such that the intermittent light from the LED indicator is visible from the sensor retainer.

### CROSS-REFERENCE TO RELATED APPLICATIONS

This application claims the benefit of U.S. Provisional Application No. 62/666,804, filed May 4, 2018; the contents of which are hereby incorporated herein by reference in their entirety.

### BACKGROUND

Unless otherwise indicated herein, the materials described in this section are not prior art to the claims in this application and are not admitted to be prior art by inclusion in this section.

In addition to a passive infrared (PIR) sensor and a photodetector, for regulatory compliance conventional light sensing and motion detection products require a light-emitting diode (LED), typically a flashing LED, to signal that the device is operating. These products typically compartmentalize or separate the fit and function of the PIR sensor lens, the light pipe for ambient light sensing by the photodetector, and the visible LED. This compartmentalization results in a large overall footprint.

### SUMMARY

Apparatuses and methods for a multi-functional light pipe for occupancy and ambient lighting control are provided.

According to various aspects there is provided a light and motion detection sensor. In some aspects, the sensor may include a light-emitting diode (LED) indicator configured to provide intermittent light from the LED indicating that the light and motion detection sensor is operating, a photocell sensor configured to detect ambient light, a passive infrared (PIR) sensor having a lens and configured to detect infrared radiation, and a sensor retainer configured to retain the light and motion detection sensor in a mounting, transmit ambient light to the photocell sensor, and transmit the intermittent light from the LED indicator such that the intermittent light from the LED indicator is visible from the sensor retainer.

The sensor retainer of the light and motion detection sensor may be a translucent material and may be configured to retain the lens for the PIR sensor. In some implementations, the sensor retainer may include the lens for the PIR sensor. The sensor retainer may further include a first surface exposed to ambient light. The first surface may have a textured surface finish to enhance collection of ambient light.

The sensor retainer of the light and motion detection sensor may include a first light pipe portion disposed substantially adjacent to the LED indicator, and a second light pipe portion disposed substantially adjacent to the photocell sensor. The first light pipe portion and the second light pipe portion may be a translucent material. The first light pipe portion may have a polished surface finish facing the LED indicator. The second light pipe portion may have a polished surface finish facing the photocell sensor.

According to various aspects there is provided a sensor retainer. In some aspects, the sensor retainer may include a first light pipe portion configured to guide light generated by a light-emitting diode indicator, a second light pipe portion configured to guide ambient light to a photocell sensor, and a light ring in optical communication with the first light pipe portion and the second light pipe portion. The light ring may be configured to transmit visible light from the first light pipe portion such that the light generated by the LED indicator is visible from the light ring, and to transmit ambient light to the second light pipe portion such that ambient light is visible to the photocell sensor.

The sensor retainer may further include a plurality of retaining slots configured to engage with a corresponding plurality of sensor retainer latches included on a sensor housing. The combination of the plurality of retaining slots and the plurality of sensor latches may retain the sensor housing to a panel. The sensor retainer may retain a light and motion detection sensor to the panel.

The sensor retainer may further include a center opening configured to accept a lens for a passive infrared (PIR) sensor and may retain the lens for the PIR sensor. In some implementations, the sensor retainer may include the lens for the passive infrared (PIR) sensor.

The light ring of the sensor retainer may include a first surface exposed to ambient light. The first surface may have a textured surface finish to enhance collection of ambient light. The first light pipe portion may be positioned substantially adjacent to the LED indicator. The second light pipe portion may be positioned substantially adjacent to the photocell sensor. The light ring, the first light pipe portion and the second light pipe portion may be a translucent material. The first light pipe portion may have a first polished surface finish facing the LED indicator. The second light pipe portion may have a second polished surface finish facing the photocell sensor.

According to various aspects there is provided a method for operating a light and motion detection sensor. In some aspects, the method may include turning on a light-emitting diode (LED) indicator and determining whether an LED on-time has elapsed. In response to determining that the LED on-time has elapsed, the method may further include turning off the LED indicator, receiving a signal from a photocell sensor, and determining whether an LED off-time has elapsed. In response to determining that the LED off-time has elapsed, the method may further include blanking the signal from the photocell sensor; and turning on the LED indicator. The LED on-time and off-time may occur at a predetermined frequency. The light generated by the LED may be transmitted via a light pipe to a light ring positioned external to a housing of the light and motion detection sensor. The light generated by the LED may be visible as an indicator that the light and motion detection sensor is operational.

Numerous benefits are achieved by way of the various embodiments over conventional techniques. For example, the various embodiments provide a unique multi-purposed mechanical light pipe feature that shrinks occupancy detection, and enables ambient light sensory recognition inside lighting fixture designs. These and other embodiments along with many of its advantages and features are described in more detail in conjunction with the text below and attached figures.

### BRIEF DESCRIPTION OF THE DRAWINGS

Aspects and features of the various embodiments will be more apparent by describing examples with reference to the accompanying drawings, in which:

FIG. 1A is an exploded perspective view of a light and motion detection sensor and a sensor retainer according to various aspects of the present disclosure;

FIG. 1B is a top view of the upper housing according to various aspects of the present disclosure;

FIG. 1C is a perspective view of the sensor retainer according to various aspects of the present disclosure;

FIG. 2 is a cross-section of the light and motion detection sensor according to various aspects of the present disclosure;

FIG. 3A is a top view 300 of the light and motion detection sensor mounted in a panel according to various aspects of the present disclosure;

FIG. 3B is a side view of the light and motion detection sensor mounted in a panel according to various aspects of the present disclosure;

FIG. 4 is a flowchart of a method for controlling the operation of the LED indicator and the photocell sensor according to various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

In accordance with various aspects of the present disclosure, a single sensor retainer part serves a multifunctional purpose for transmitting light to and from sensors and indicators while providing clean aesthetics and an easy to assemble snap fit producing a unique and small overall product size. The sensor retainer (i.e., the multi-functional light pipe) overcomes problems of conventional fixture retaining parts having separate cavities for the occupancy lens (i.e., for a PIR sensor) and the two light pipes used for the LED indicator and the photodetector that senses light for ambient lighting control. In accordance with various aspects of the present disclosure, the sensor retainer (i.e., multi-functional light pipe) minimizes the footprint of the sensor on the overall lighting fixture and combines three separate parts into one part with the following attributes: 1) the number of separate cavities is reduced by use of a translucent material; 2) the LED indicator and photocell sensor are isolated by the geometry of the device; 3) the sensor retainer has hole features that allow it to attach to snap features of the housing; and 4) the sensor retainer is esthetically designed for architectural requirements of minimal intrusiveness.

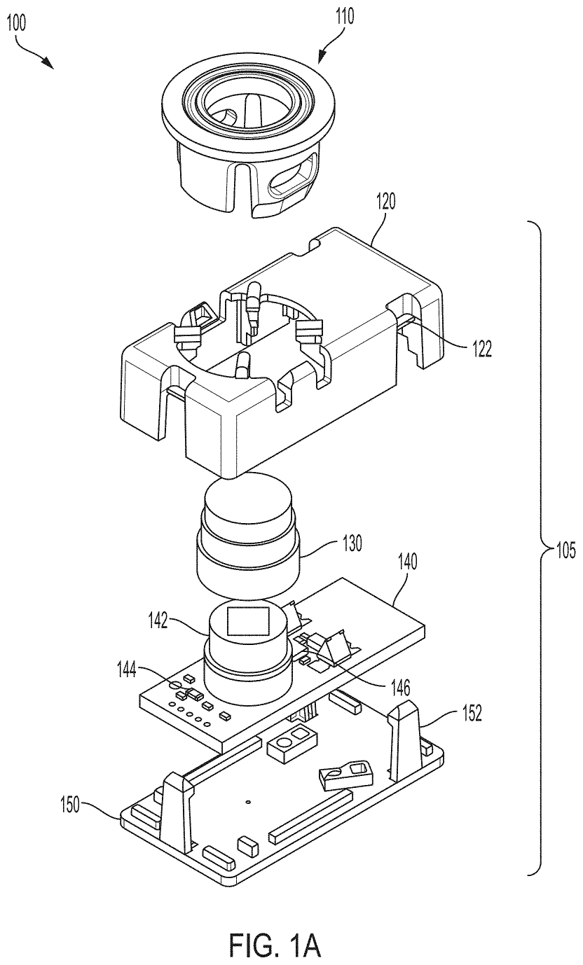

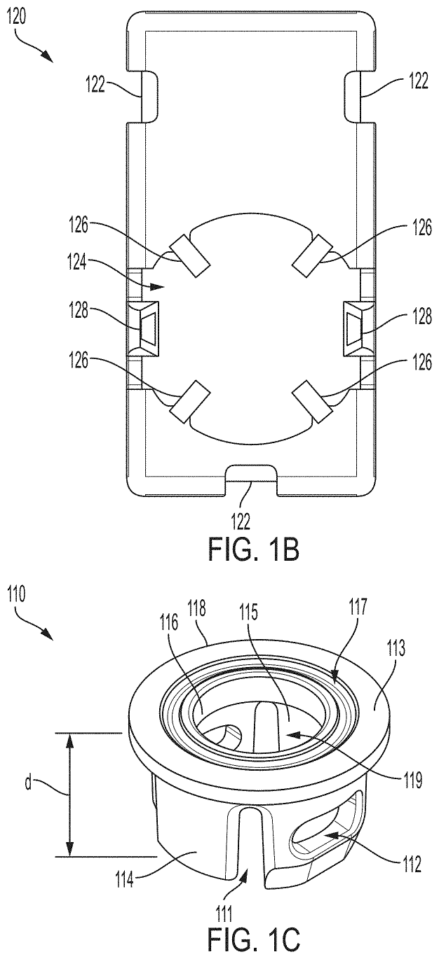

FIG. 1A is an exploded perspective view of a light and motion detection sensor 100 and a sensor retainer 110 according to various aspects of the present disclosure. As illustrated in FIG. 1A, the light and motion detection sensor 100 may include a housing assembly 105 including an upper housing 120 and a lower housing 150. A PIR lens 130 and a printed circuit board (PCB) assembly 140 may be contained within the housing assembly 105. The lower housing 150 may accommodate the PCB assembly 140 and may include a plurality of latches 152 configured to attach the lower housing 150 to the upper housing 120. The sensor retainer (i.e., multi-functional light pipe) 110 may retain the light and motion detection sensor 100 in a mounted configuration. According to various aspects of the present disclosure, a microphone (not shown) may be incorporated into the light and motion detection sensor 100. For example, the sensor retainer 110 may include an acoustic hole disposed in the light ring 118 to admit external sound to the microphone.

The PCB assembly 140 may include the PIR sensor 142, the LED indicator 144, and the photocell sensor 146. A PIR sensor 142 may be disposed within the PIR lens 130. The PIR lens 130 may be configured to focus infrared radiation on the PIR sensor 142. The PIR sensor 142 may detect motion. The LED indicator 144 and the photocell sensor 146 may be disposed on the PCB assembly 140 around a perimeter envelope of the PIR sensor 142. While the LED indicator 144 and the photocell sensor 146 are depicted in FIG. 1 as being opposite each other with the PIR sensor 142 between them such that the PIR sensor 142 “shades” the LED indicator 144 from the photocell sensor 146, the LED indicator 144 and the photocell sensor 146 may be positioned at any points relative to each other around the perimeter of the PIR sensor 142 without departing from the scope of the present disclosure.

FIG. 1B is a top view of the upper housing 120 according to various aspects of the present disclosure. Referring to FIG. 1B, the upper housing 120 may include a plurality of retaining portions 122, an opening 124, a plurality of positioning pins 126 and a plurality of sensor retainer latches 128. The plurality of retaining portions 122 may be configured to accept and retain the plurality of latches 152 of the lower housing 150. The opening 124 may be configured to accept the sensor retainer 110. While the opening 124 is depicted in FIG. 1 as being substantially circular, one of ordinary skill in the art will appreciate that other hole configurations, for example, but not limited to, square, rectangular, oval, etc., may be used without departing from the scope of the present disclosure. The PIR lens 130 may protrude through the opening 124 in the upper housing 120.

FIG. 1C is a perspective view of the sensor retainer 110 according to various aspects of the present disclosure. Referring to FIG. 1C, the sensor retainer (i.e., the multi-functional light pipe) 110 may include a plurality of positioning slots 111 a plurality of retaining slots, 112 a first light pipe portion 114, a second light pipe portion 115, a lens retaining portion 116, and a light ring 118. The positioning slots 111 may be configured to accept the positioning pins 126 of the upper housing 120 to provide proper orientation of the sensor retainer 110. The retaining slots 112 may be configured to engage with the sensor retainer latches 128 of the upper housing 120 to secure the sensor retainer 110 to the upper housing 120. Other configurations are possible without departing from the scope of the present disclosure. For example, in some implementations, the retaining slots and/or other features may be included in the upper housing and the retainer latches and/or other features may be included in the sensor retainer.

The lens retaining portion 116 may surround the PIR lens 130 and be configured to secure the PIR lens 130 to the PIR sensor 142. The sensor retainer 110 may have a center opening 119 configured to permit protrusion of the PIR lens 130. In accordance with various aspects of the present disclosure, the sensor retainer 110 and the PIR lens 130 may be designed and fabricated as a single part.

The light ring 118 may be a substantially translucent material, for example, but not limited to acrylic, ABS plastic, etc. The upper surface 113 of the light ring 118 may have a substantially smooth profile and may be exposed to ambient light. The surface finish of the upper surface 113 may be textured to diffuse the ambient light and enhance collection of ambient light impinging on the upper surface 113 from various angles. In some implementations, one or more annular grooves 117 may be incorporated into the upper surface 113 of the light ring 118. Surfaces of the sensor retainer 110 other than the upper surface 113 of the light ring 118 may be polished surfaces.

The light ring 118 may admit the collected light to the photocell sensor 146 via the first light pipe portion 114, and may transmit light from the LED indicator 144 via the second light pipe portion 115. The light transmitted from the LED indicator 144 may be visible from the light ring 118. The first light pipe portion 114 and the second light pipe portion 115 may be the same substantially translucent material as the light ring 118. The first light pipe portion 114 and the second light pipe portion 115 may have a polished surface finish to more efficiently transmit light. The first light pipe portion 114 may be positioned in proximity to the LED indicator 144 and may transmit light from the LED indicator 144 to the light ring 118. The second light pipe portion 115 may be positioned in proximity to the photocell sensor 146 and may transmit ambient light from the light ring 118 to the photocell sensor 146.

A dimension “d” of the sensor retainer 110 from the bottom of the first and second light pipes 114, 115 to a bottom surface of the light ring 118 may be sized to accommodate mounting materials of various thicknesses. While the sensor retainer 110 and various features thereof are depicted in FIG. 1 as being substantially circular, one of ordinary skill in the art will appreciate that other configurations, for example, but not limited to, square, rectangular, oval, etc., may be used without departing from the scope of the present disclosure.

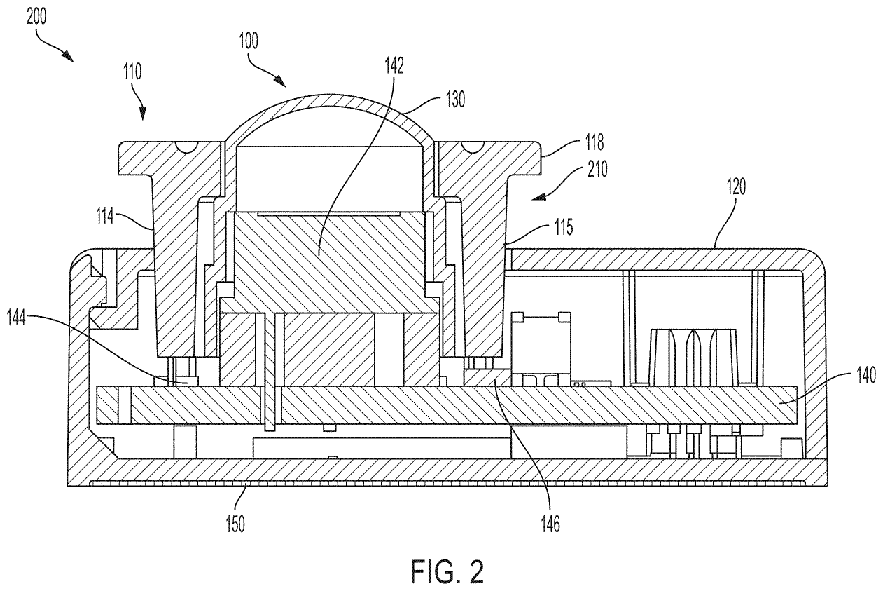

FIG. 2 is a cross-sectional view 200 of the light and motion detection sensor 100 and sensor retainer 110 according to various aspects of the present disclosure. Referring to FIG. 2, the LED indicator 144 and the photocell sensor 146 may be disposed on the PCB assembly 140 in proximity to the perimeter of the PIR sensor 142. The sensor retainer 110 may be configured to retain the PIR lens 130. As illustrated in FIG. 2, the PIR lens 130 may have a stepped configuration. Other configurations of the PIR lens 130 are possible, for example, but not limited to, a single shoulder or a taper to provide an interference fit enabling the sensor retainer 110 to retain the PIR lens 130.

The first light pipe portion 114 may be positioned in proximity to the LED indicator 144, for example, substantially adjacent to the LED indicator 144, with no obstruction to impede light transmission between the LED indicator 144 and the first light pipe portion 114. The first light pipe portion 114 may be a translucent material and may have a polished surface finish facing the LED indicator 144 to permit efficient light transfer from the LED indicator 144 to the first light pipe portion 114.

The second light pipe portion 115 may be positioned in proximity to the photocell sensor 146, for example, substantially adjacent to the photocell sensor 146, with no obstruction to impede light transmission between the second light pipe portion 115 and the photocell sensor 146. The second light pipe portion 115 may be a translucent material and may have a polished surface finish facing the photocell sensor 146 to permit efficient light transfer from the second light pipe portion 115 to the photocell sensor 146. The light ring 118 may be positioned adjacent to the upper housing 120 such that light may be transmitted between the light ring 118 and the first and second light pipe portions 114, 115. While the first and second light pipe portions 114, 115 are illustrated as being substantially perpendicular to the light ring 118, other configurations are possible. For example, the first and second light pipe portions 114, 115 may be angled away from the PIR sensor 142 or may have stepped configurations to permit alternate placements of the LED indicator 144 and/or the photocell sensor 146. Many variations, modifications, and alternatives may be recognized without departing from the scope of the present disclosure.

The LED indicator 144 may flash on and off at a predetermined repetition rate to indicate that the light and motion detection sensor 100 is operational. In accordance with various aspects of the present disclosure, the LED indicator 144 may not be illuminated during the same period of time when the photocell sensor 146 is operating to detect ambient light. The flashing of the LED indicator 144 and the ambient light sensing by the photocell sensor 146 may be synchronized by firmware in the light and motion detection sensor 100. Firmware operating on a controller (not shown), for example, but not limited to, a processor, microprocessor, microcontroller, or other programmable device, configured to control the operation of the light and motion detection sensor 100 may control the repetition rate of the LED indicator 144 and may cause the photocell sensor 146 to sense ambient light conditions only during periods of time when the LED indicator 144 is not illuminated.

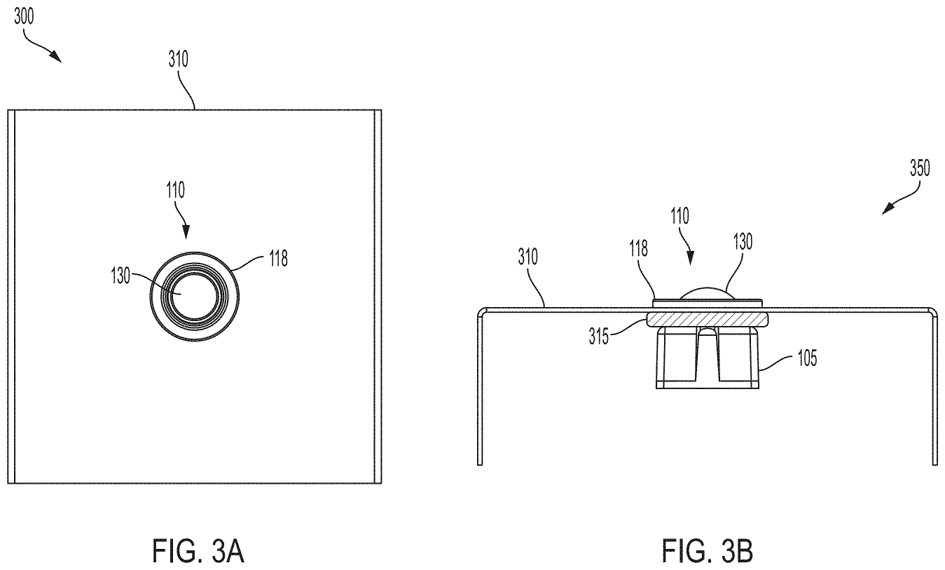

FIG. 3A is a top view 300 of the light and motion detection sensor 100 mounted in a panel with the sensor retainer 110 according to various aspects of the present disclosure. FIG. 3B is a side view 350 of the light and motion detection sensor 100 mounted in a panel with the sensor retainer 110 according to various aspects of the present disclosure. One of ordinary skill in the art will appreciate that the light and motion detection sensor 100 may be mounted to a fixture or remote mounted (e.g., on a wall or ceiling, etc., without a fixture) without departing from the scope of the present disclosure.

Referring to FIGS. 3A and 3B, the light and motion detection sensor 100 may be mounted to a panel 310 of any suitable material, for example, but not limited to, plastic, metal, wood, or another material, having an appropriate thickness, for example, ⅛ inch or another thickness. Referring to FIG. 1C, a dimension “d” of the sensor retainer 110 may be sized to provide a gap 210 between the light ring 118 and the upper housing 120 of the housing assembly 105 to accommodate mounting materials of various thicknesses. An appropriately sized hole, for example, ⅝ inch or another size, may be made in the panel 310 to accommodate the sensor retainer 110. The light ring 118 may extend beyond the hole. As illustrated in FIG. 3A, when installed in the panel 310, the PIR lens 130 and the light ring 118 of the sensor retainer 110 are visible. A gasket 315 may be positioned between the housing assembly 105 and the panel 310. The gasket 315 may be fabricated from a resilient elastomeric material, for example, but not limited to, a silicon rubber material, that may be compressed to retain the housing assembly 105 to the panel 310 when the sensor retainer 110 is inserted. Alternatively, the gasket 315 may be fabricated from a rigid material, for example, but not limited to, ABS plastic.

When mounting the light and motion detection sensor 100 to the panel 310, the housing assembly 105 and the gasket 315 may be positioned on one side of the panel 310 and the sensor retainer 110 inserted through the hole and the gasket 315 from the opposite side of the panel 310 to engage the retaining slots 112 of the sensor retainer 110 with the sensor retainer latches 128 of the upper housing 120 to secure the sensor retainer 110 to the upper housing 120, thereby securing the light and motion detection sensor 100 to the panel 310. In some implementations, the sensor retainer 110 and the gasket 315 may be positioned on one side of the panel 310 with the gasket 315 positioned between the light ring 118 and the panel 310, and the housing assembly 105 positioned on the opposite side of the panel 310.

In some implementations, the light and motion detection sensor 100 may be integrated into a lighting fixture. For example, the panel 310 may be a portion of a light fixture enclosure and the light and motion detection sensor 100 may be mounted to the portion of the light fixture enclosure such that the PIR lens 130 and the light ring 118 of the sensor retainer 110 are visible. In some implementations, the light and motion detection sensor 100 may be remote from the lighting fixture, for example mounted in a wall plate, and in wired or wireless communication with the light fixture or a controller or other component.

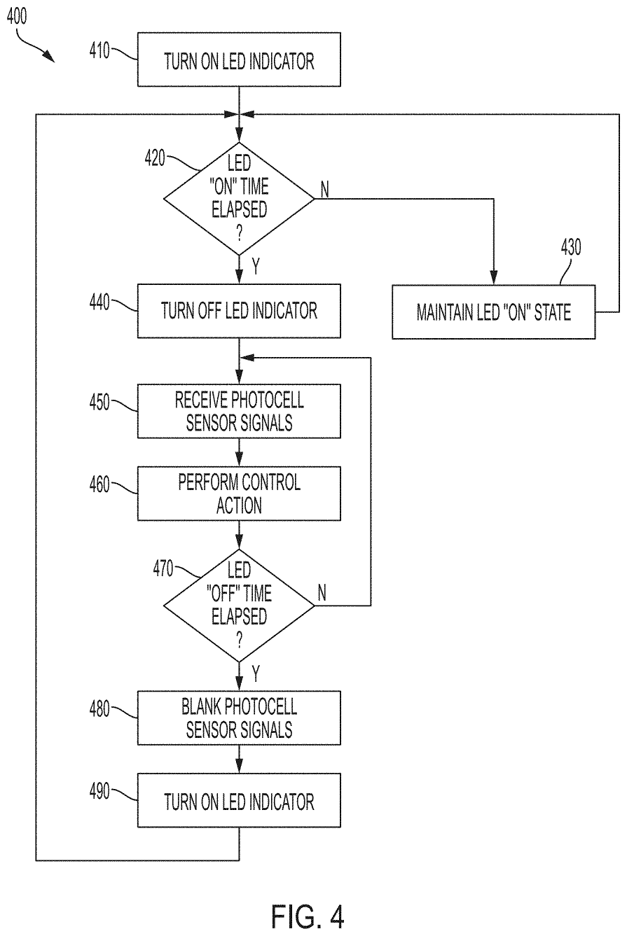

According to various aspects of the present disclosure, the operation of the LED indicator 144 and the photocell sensor 146 may be controlled by firmware. FIG. 4 is a flowchart of a method 400 for controlling the operation of the LED indicator 144 and the photocell sensor 146 according to various aspects of the present disclosure. Referring to FIG. 4, at block 410 the controller may cause the LED indicator 144 to turn on. The LED indicator 144 may flash at a specified repetition rate. At block 420, the controller may determine whether the specified on-time for the LED indicator 144 has elapsed. In response to determining that the specified on-time for the LED indicator 144 has not elapsed (420-N), at block 430 the controller may cause the LED indicator 144 to maintain the “on” state.

In response to determining that the specified on-time for the LED indicator 144 has elapsed (420-Y), at block 440 the controller may cause the LED indicator 144 to change to an “off” state for a specified period of time. At block 450, the controller may receive signals from the photocell sensor 146 based on ambient light conditions and/or infrared radiation detection (i.e., motion detection) from the PIR sensor 142 during the specified period of time the LED indicator is in the “off” state. In response to receiving the signal from the photocell sensor 146, at block 460 the light and motion detection sensor 100 may perform a control action, for example, but not limited to, turning a light or other device on or off, initiating an alarm, etc. The control action may be to perform no action in response to the signal from the photocell sensor 146. One of ordinary skill in the art will appreciate that a wide variety of control actions may be performed by the light and motion detection sensor 100 without departing from the scope of the present disclosure.

At block 470, the controller may determine whether the specified period of time the LED indicator 144 is in the “off” state has elapsed. In response to determining that the specified period of time the LED indicator 144 is in the “off” state has not elapsed (470-N), the controller may continue to receive signals from the photocell sensor 146 at block 460. In response to determining that the specified period of time the LED indicator 144 is in the “off” state has elapsed (470-Y), at block 480 the controller may blank or ignore the signal from the photocell sensor 146. At block 490, the controller may cause the LED indicator 144 to turn on for the specified period of time and the process may continue at block 430.

The method 400 may be embodied on a non-transitory computer readable medium, for example, but not limited to, a memory or other non-transitory computer readable medium known to those of skill in the art, having stored therein a program including processor executable instructions for making a processor, computer, or other programmable device execute the operations of the method.

It should be appreciated that the specific operations illustrated in FIG. 4 provide a particular method for controlling the operation of an LED indicator and a photocell sensor according to an embodiment of the present invention. Other sequences of operations may also be performed according to alternative embodiments. For example, alternative embodiments may perform the operations outlined above in a different order. Moreover, the individual operations illustrated in FIG. 4 may include multiple sub-operations that may be performed in various sequences as appropriate to the individual operations. Furthermore, additional operations may be added or removed depending on the particular applications. Many variations, modifications, and alternatives may be recognized without departing from the scope of the present disclosure.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A light and motion detection sensor, comprising:
a light-emitting diode (LED) indicator configured to provide intermittent light from the LED indicating that the light and motion detection sensor is operating;
a photocell sensor configured to detect ambient light;
a passive infrared (PIR) sensor having a lens, the PIR sensor configured to detect infrared radiation; and
a sensor retainer configured to retain the light and motion detection sensor in a mounting, transmit ambient light to the photocell sensor, and transmit the intermittent light from the LED indicator such that the intermittent light from the LED indicator is visible from the sensor retainer.

2. The light and motion detection sensor of claim 1, wherein the sensor retainer comprises a translucent material.

3. The light and motion detection sensor of claim 1, wherein the sensor retainer is configured to retain the lens for the PIR sensor.

4. The light and motion detection sensor of claim 1, wherein the sensor retainer comprises the lens for the PIR sensor.

5. The light and motion detection sensor of claim 1, wherein:
the sensor retainer comprises a first surface configured to be exposed to ambient light, and
the first surface has a textured surface finish configured to enhance collection of ambient light.

6. The light and motion detection sensor of claim 1, wherein:
the sensor retainer comprises a first light pipe portion disposed substantially adjacent to the LED indicator, and
a second light pipe portion disposed substantially adjacent to the photocell sensor.

7. The light and motion detection sensor of claim 6, wherein the first light pipe portion and the second light pipe portion comprise a translucent material.

8. The light and motion detection sensor of claim 7, wherein:
the first light pipe portion has a first polished surface finish facing the LED indicator,
and the second light pipe portion has a second polished surface finish facing the photocell sensor.

9. A sensor retainer, comprising:
a first light pipe portion configured to guide light generated by a light-emitting diode indicator;
a second light pipe portion configured to guide ambient light to a photocell sensor; and
a light ring in optical communication with the first light pipe portion and the second light pipe portion, the light ring configured to transmit visible light from the first light pipe portion such that the light generated by the LED indicator is visible from the light ring, and to transmit ambient light to the second light pipe portion such that ambient light is visible to the photocell sensor.

10. The sensor retainer of claim 9, further comprising:
a plurality of retaining slots configured to engage with a corresponding plurality of sensor retainer latches comprising a sensor housing, the combination of the plurality of retaining slots and the plurality of sensor latches configured to retain the sensor housing to a panel.

11. The sensor retainer of claim 10, wherein the sensor retainer is configured to retain a light and motion detection sensor to the panel.

12. The sensor retainer of claim 9, further comprising:
a center opening configured to accept a lens for a passive infrared (PIR) sensor,
the sensor retainer further configured to retain the lens for the PIR sensor.

13. The sensor retainer of claim 9, further comprising a lens for a passive infrared (PIR) sensor.

14. The sensor retainer of claim 9, wherein:
the light ring comprises a first surface configured to be exposed to ambient light, and
the first surface has a textured surface finish configured to enhance collection of ambient light.

15. The sensor retainer of claim 9, wherein:
the first light pipe portion is disposed substantially adjacent to the LED indicator, and
the second light pipe portion is disposed substantially adjacent to the photocell sensor.

16. The sensor retainer of claim 9, wherein the light ring, the first light pipe portion and the second light pipe portion comprise a translucent material.

17. The sensor retainer of claim 16, wherein:
the first light pipe portion has a first polished surface finish facing the LED indicator,
and the second light pipe portion has a second polished surface finish facing the photocell sensor.

18. A method for operating a light and motion detection sensor, the method comprising:
turning on a light-emitting diode (LED) indicator;
determining whether an LED on-time has elapsed;
in response to determining that the LED on-time has elapsed, turning off the LED indicator;
receiving a signal from a photocell sensor;
determining whether an LED off-time has elapsed;
in response to determining that the LED off-time has elapsed, blanking the signal from the photocell sensor; and
turning on the LED indicator.

19. The method of claim 18, wherein the LED on-time and off-time occur at a predetermined frequency.

20. The method of claim 18, wherein the light generated by the LED is transmitted via a light pipe to a light ring disposed external to a housing of the light and motion detection sensor and is visible as an indicator that the light and motion detection sensor is operational.
